(19) United States
(12) Patent Application Publication
(10) Pub. No.: US 2010/0129005 A1
(43) Pub. Date: May 27, 2010

(54) SYSTEM AND METHOD FOR AUTOMATED SCAN PLANNING USING SYMMETRY DETECTION AND IMAGE REGISTRATION

(75) Inventors: Xiaodong Tao, Niskayuna, NY (US); Sandeep Narendra Gupta, Clifton Park, NY (US)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 12/603,778

(22) Filed: Oct. 22, 2009

Related U.S. Application Data
(60) Provisional application No. 61/118,111, filed on Nov. 26, 2008.

(51) Int. Cl. G06K 9/36

(52) U.S. Cl. 382/291

(57) ABSTRACT

A method of determining an anatomically consistent scan protocol for an object of interest includes obtaining a volumetric image of an object of interest to be imaged, transforming the volumetric image, estimating the position and orientation of the object using the volumetric image and the transformed volumetric image, and modifying the imaging scan protocol using the estimated object position and orientation.

### CROSS REFERENCE TO RELATED APPLICATIONS

This Non-provisional application hereby claims priority to U.S. Provisional Patent Application No. 61/118,111, entitled “SYSTEM AND METHOD FOR AUTOMATED SCAN PLANNING USING SYMMETRY DETECTION AND IMAGE REGISTRATION”, filed Nov. 26, 2008, which is herein incorporated by reference.

### BACKGROUND

Embodiments of the invention relate generally to imaging techniques and more particularly to a system and method for automated scan planning using symmetry detection and image registration.

In current Magnetic resonance imaging (MRI) acquisition processes, scout or localizer images of an object to be imaged are typically acquired before any diagnostic images are acquired. An operator reviews the localizer images and manually sets scanning parameters to acquire images of the object in a way that provides the most diagnostic or scientific values. Such MR imaging processes are very demanding on the operator requiring specific knowledge and skill. For example, it requires that the operator be able to recognize the patient orientation from the orthogonal views of the localizer images and determine the scan planes that are necessary to produce object images that conform to the standard views, or desired views. Furthermore, current MR imaging processes may also suffer from inconsistency between operators and between imaging sessions for the same operator.

Previous work in this area typically relied on detection of anatomical landmarks, such as the anterior and posterior commissures as well as the sagittal sinus from the localizer image, aligning the coordinates of these landmarks to the coordinates of the same set of landmarks in an atlas (e.g., the Talairach atlas), and applying the transform from the alignment to prescribe the scan planes. There is also prior work that uses statistical atlases (i.e., a reference constructed from images of a number of objects). A statistical atlas represents an object in a probabilistic fashion. When applied in a registration framework, the statistical atlas can help determine the transform required to align the localizer image of the object to that standard space. However, statistical atlases are limited to the population they are derived from and therefore may not represent a particular patient anatomy.

It is therefore desirable to provide automated scan planning with improved image quality that are not dependent on the knowledge and skills of the operators of the imaging device.

### BRIEF DESCRIPTION

In accordance with one aspect of the invention, a method of determining an anatomically consistent imaging scan protocol for an object of interest is presented. The method includes obtaining a volumetric image of an object of interest to be imaged, transforming the volumetric image, estimating a position and orientation of the object using the volumetric image and the transformed volumetric image, and modifying the imaging scan protocol using the estimated object position and orientation.

In accordance with another aspect of the invention, a machine readable medium comprising instructions is presented. The instructions, when executed by a processor cause an imaging system to obtain a volumetric image of an object of interest to be imaged, transform the volumetric image, estimate a position and orientation of the object using the volumetric image and the transformed volumetric image, and modify the imaging scan protocol using the estimated object position and orientation.

In accordance with yet another aspect of the invention, a magnetic resonance imaging system is presented. The magnetic resonance imaging system comprising a machine readable medium including instructions, which when executed by a processor cause the imaging system to obtain a volumetric image of an object of interest to be imaged, transform the volumetric image, estimate a position and orientation of the object using the volumetric image and the transformed volumetric image, and modify the imaging scan protocol using the estimated object position and orientation.

### DRAWINGS

These and other features, aspects, and advantages of the present invention will become better understood when the following detailed description is read with reference to the accompanying drawings in which like characters represent like parts throughout the drawings, wherein:

FIG. 1 illustrates one embodiment of an imaging system for generating digital images of an object to be imaged;

FIG. 2 is a flow diagram illustrating a method for determining an anatomically consistent scan protocol in accordance with one embodiment;

FIG. 3 is a block diagram illustrating one embodiment of an image registration process for aligning the volumetric image to its flipped version;

FIG. 4 is a block diagram illustrating an image registration process for aligning an image of an object's mid-sagittal plane to a reference mid-sagittal plane image;

FIG. 5 is a schematic diagram illustrating use of a transform T_{F} to generate a new scan plane in accordance with one embodiment;

FIG. 6 illustrates nine consecutive slices of an axial volumetric localizer image of a human brain;

FIG. 7 illustrates one image slice in the localizer image and its flipped version around the initial guess of the plane of symmetry;

FIG. 8 illustrates a transformed version of the image slice from FIG. 7;

FIG. 9 illustrates an image of the mid-sagittal plane and a reference mid-sagittal plane image;

FIG. 10 illustrates a transform of an image of the mid-sagittal plane of the object transformed to be imaged;

FIG. 11 is a screen shot illustrating a processing system using the information of the position and orientation of the object to prescribe the imaging planes and field of views to acquire diagnostic images in accordance with embodiments of the invention;

FIG. 12 illustrates additional screen shots on an MR scanner console; and

FIG. 13 illustrates results of scans prescribed using the methods and systems described herein.

### DETAILED DESCRIPTION

Embodiments of the present invention are generally directed to a system and method for automatically determining the position and orientation of an object being imaged using a volumetric localizer image of the object and using the information of the position and orientation of the object to prescribe scan planes that are not dependent on the knowledge and skills of the operators of the imaging device.

In the following detailed description, numerous specific details are set forth in order to provide a thorough understanding of various embodiments of the present invention. However, those skilled in the art will understand that embodiments of the present invention may be practiced without these specific details, that the present invention is not limited to the depicted embodiments, and that the present invention may be practiced in a variety of alternative embodiments. In other instances, well known methods, procedures, and components have not been described in detail.

Furthermore, various operations may be described as multiple discrete steps performed in a manner that is helpful for understanding embodiments of the present invention. However, the order of description should not be construed as to imply that these operations need be performed in the order they are presented, nor that they are even order dependent. Moreover, repeated usage of the phrase “in one embodiment” does not necessarily refer to the same embodiment, although it may. Lastly, the terms “comprising”, “including”, “having”, and the like, as well as their inflected forms as used in the present application, are intended to be synonymous unless otherwise indicated.

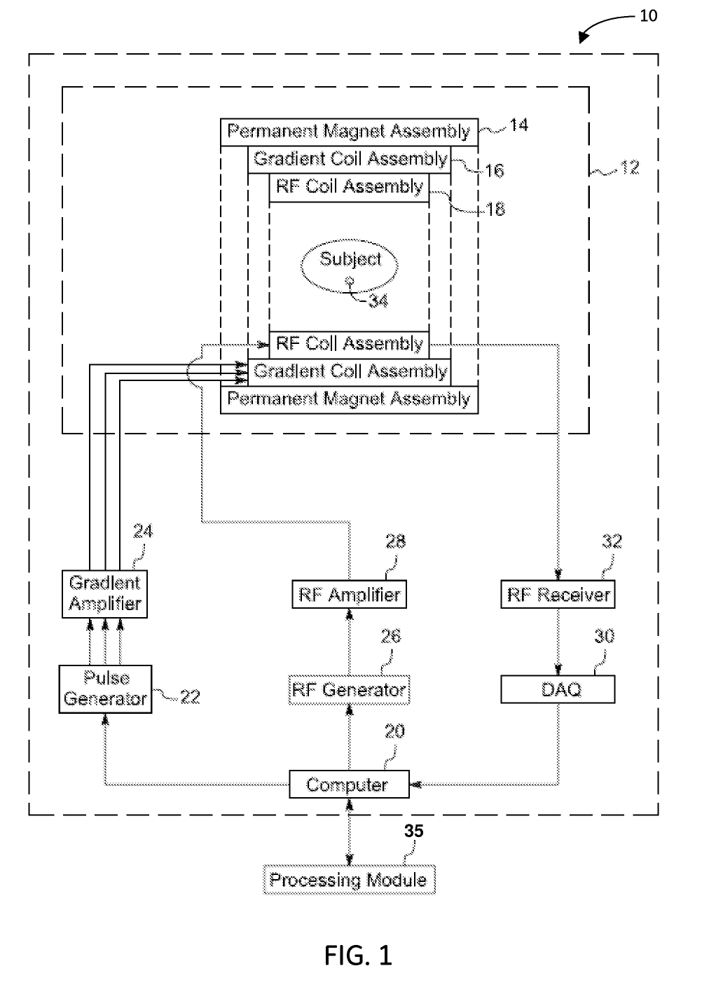

Referring now to FIG. 1, an imaging system 10 for generating digital images of an object to be imaged, in accordance with an exemplary aspect of the present technique is illustrated. In the illustrated embodiment, the imaging system 10 is an MR imaging system including a scan unit 12, which is capable of scanning an object 34 and generating an image of an object 34 based on the magnetic resonance signals generated in the object 34 by emitting radio frequency (RF) pulses to the object 34 in a static magnetic field space. It may be noted that in one embodiment, the object 34 may include a patient. Although the present technique is described in terms of the object 34 including a patient, it may be noted that the present technique may also be applied to imaging other objects.

Although the exemplary embodiments illustrated hereinafter are described in the context of a MR imaging system, other imaging systems and applications such as industrial imaging systems and non-destructive evaluation and inspection systems, such as pipeline inspection systems, liquid reactor inspection systems, are also contemplated. Additionally, the exemplary embodiments illustrated and described hereinafter may find application in multi-modality imaging systems that employ an imaging system in conjunction with other imaging modalities, position-tracking systems or other sensor systems. Furthermore, it should be noted that the imaging system 10 may include imaging systems, such as, but not limited to, an X-ray imaging system, an ultrasound imaging system, a positron emission tomography (PET) imaging system, a computed tomography (CT) imaging system, or the like.

In the embodiment illustrated in FIG. 1, the imaging system 10 includes a permanent magnet assembly 14, a gradient coil assembly 16, an RF coil assembly 18, a computer 20, a pulse generator 22, a gradient amplifier 24, an RF generator 26, an RF amplifier 28, a data acquisition unit 30, and an RF receiver 32. The permanent magnetic assembly 14 may include a pair of permanent magnets, for example. The pair of permanent magnets may form a static magnetic field in the imaging area in which the object 34 is carried. While imaging system 10 may include any suitable MRI scanner or detector, in the illustrated embodiment the system includes a full body scanner comprising a bore (not shown) into which a table (not shown) may be positioned to place an object 34 in a desired position for scanning The static field may be formed such that the direction of the static field extends along a direction perpendicular to a direction of the bore axis. Scan unit 12 may be of any suitable type of rating, and may include scanners varying from 0.5 Tesla ratings to 1.5 Tesla ratings and beyond.

Scan unit 12 includes a series of associated coils for producing controlled magnetic fields, for generating radiofrequency (RF) excitation pulses, and for detecting emissions from gyromagnetic material within the object 34 in response to such pulses. A gradient coil assembly 16 is used for generating controlled magnetic gradient fields during examination sequences. An RF coil assembly 18 is provided for generating radiofrequency pulses for exciting the gyromagnetic material. In one embodiment, the permanent magnetic assembly 14 may be made of superconducting magnets.

Moreover, the pulse generator 22 may be configured to generate gradient signals. These gradient signals may be amplified by the gradient amplifier 24 and transmitted to the gradient coil assembly 16, in response to a control signal received from the computer 20. Additionally, in response, the gradient coil assembly 16 may be configured to produce magnetic field gradients in the scanning region, where the magnetic field gradients may be employed to aid in spatially encoding acquired signals.

In addition, the RF generator 26 may be configured to generate signals that are amplified by the RF amplifier 28 and transmitted to the RF coil assembly 18, in response to a control signal received from the computer 20. In response, the RF coil assembly 18 may be configured to generate RF signals that propagate through the object 34 in the scanning region. These RF signals propagating through the object 34 may in turn be configured to induce nuclei in predetermined regions of the object 34 to emit RF signals that may be received by the RF receiver 32. The received RF signals may then be digitized by the data acquisition unit 30. In one embodiment, the data acquisition unit 30 may employ a phase detector device to detect a phase of the magnetic resonance signals received by the RF coil assembly 14. Additionally, the data acquisition unit 30 may use an analog-to-digital converter (ADC) to convert analog magnetic resonance signals, into digital magnetic resonance signals.

The digitized signals may then be communicated to the computer 20. Computer 20 may be configured to direct the various components in the imaging system 10 to perform operations in correspondence with the scanning procedure. More particularly, the computer 20 may be configured to reconstruct an image slice corresponding to a slice of the object 34 from the acquired image data. The image so generated may then be displayed on a display device (not shown in FIG. 1) based on control signals received from the computer 20.

In accordance with further aspects of the present invention, the system 10 may include a processing module 35. The processing module 35 may be configured to perform automated scan planning using symmetry detection and image registration. More specifically, in one embodiment, processing module 35 may be configured to obtain a volumetric image of an object of interest to be imaged, transform the volumetric image, estimate the position and orientation of the object using the volumetric image and the transformed volumetric image, and modify the imaging scan protocol using the estimated object position and orientation. The processing module 35 may be implemented in hardware or as software and may be integrated as part of computer 20. In another embodiment, the processing module 35 may be located remotely from the imaging system 10 and may be communicatively coupled to the system 10 through a communications network.

Furthermore, the imaging system 10 may also include a storage unit (not shown in FIG. 1) that may be used to store data. In one embodiment, the storage unit may include memory configured to store the image data. It should be understood that any type of computer accessible memory device capable of storing the desired amount of data and/or code may be utilized by such an exemplary imaging system 10. Moreover, the storage unit may include one or more memory devices, such as magnetic, solid state, or optical devices, of similar or different types, which may be local and/or remote to the system 10. The storage unit may store data, processing parameters, and/or computer programs including one or more routines for performing the processes described herein.

With continuing reference to FIG. 1, in one exemplary embodiment, the computer 20 may be configured to generate two-dimensional (2D) digital images, three-dimensional (3D) digital images, or both 2D digital images and 3D digital images of the object to be imaged, such as of the internal anatomy of a patient, using the data received from the data acquisition unit 30.

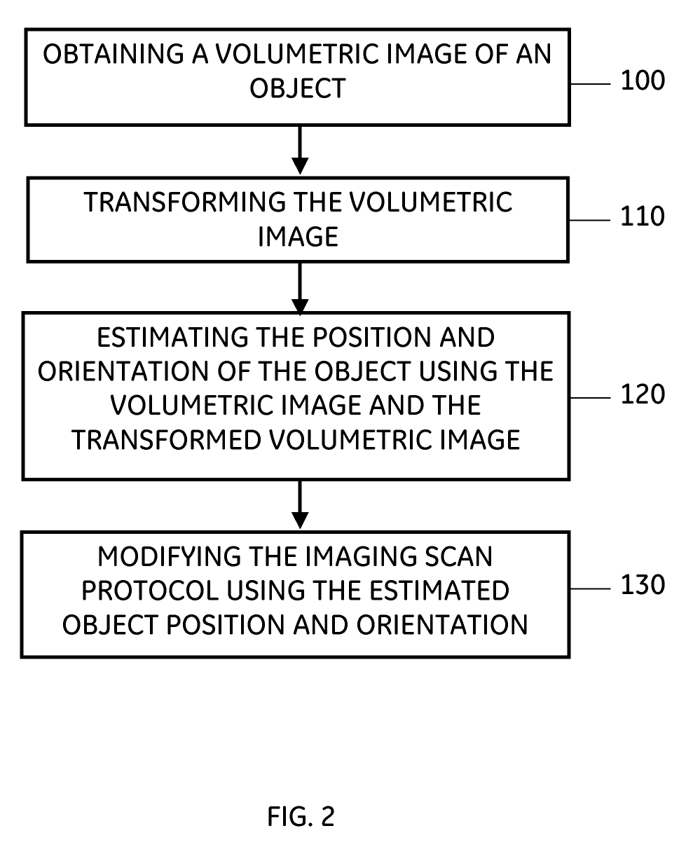

FIG. 2 is a flow diagram illustrating a method for determining an anatomically consistent scan protocol in accordance with one embodiment. In block 100, a volumetric image is obtained to cover the region of interest of the object to be imaged. In one embodiment the volumetric image is obtained through acquisition within the scan workflow. In other embodiments a previously acquired volumetric image may be retrieved from a storage device. Moreover, the volumetric image may be reconstructed from two-dimensional image “slices” or may be acquired as a three-dimensional image. In one embodiment, the volumetric image comprises a three-dimensional scout image. Such scout images are often used for localizing a patient anatomy and are not typically used for diagnostic purposes. Accordingly, the scout images typically consist of a lower resolution than images used for diagnostic purposes.

For ease of reference, the volumetric image obtained in block 100 may be referred to as L, which represents a function defined in three-dimensional space, L(x,y,z). At block 110, a rigid transform is performed on the volumetric image. The rigid transform is based on the spatial distribution of signal intensities of the object to be imaged without use of landmarks as is common in the prior art. In one embodiment, the volumetric image L(x,y,z) is reflected or flipped around an arbitrary initial guess of a plane of symmetry for the object. In an embodiment where the initial guess of the plane of symmetry is the plane x=0, the flipped version of the localizer image may be represented by J(x,y,z)=L(−x,y,z). A registration step is then employed to align J(x,y,z) to L(x,y,z) resulting in the rigid transform, T through which the image may be translated and rotated while the size remains constant.

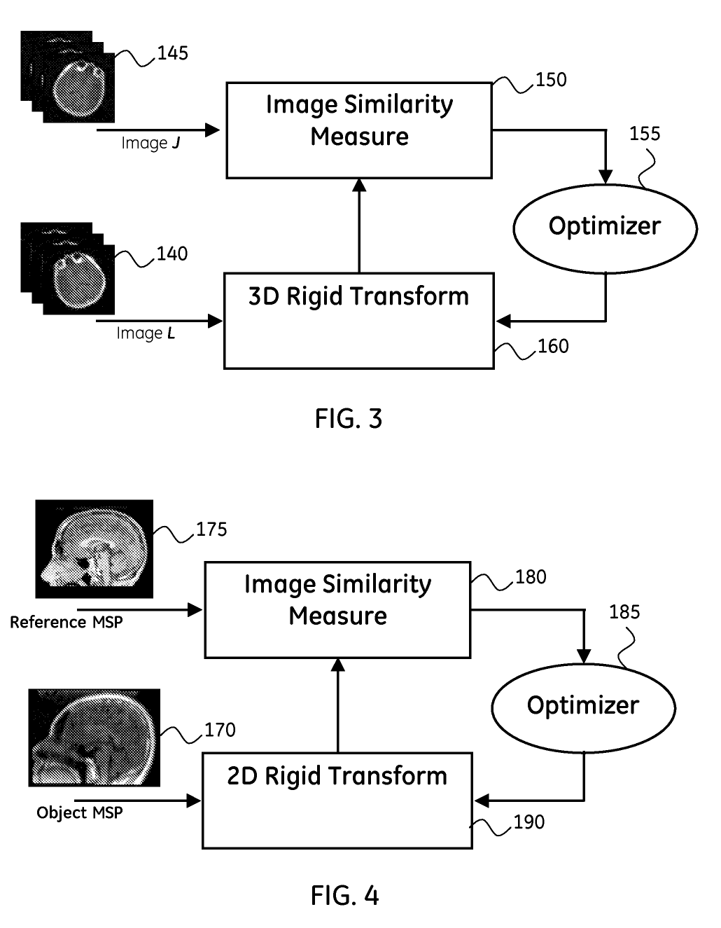

Skipping ahead to FIG. 3, a block diagram illustrating one embodiment of an image registration process for aligning the volumetric image L(x,y,z) (140) to its flipped version J(x,y,z) (145) is shown. In the illustrated embodiment, the image registration process is an iterative process through which an image similarity measure 150 is used to quantify the similarity between the two images (L, J). The similarity measure may represent any of a number of known or yet to be developed similarity metrics including mutual information, cross-correlation, or a least-squares error metric. In one embodiment, an optimization process 155 is used to update the transform between the two images, J(x,y,z) and L(x,y,z) using the three-dimensional rigid transform 160 so as to maximize the similarity measure between J(x,y,z) and L(x,y,z).

In one embodiment, once J(x,y,z) and L(x,y,z) are registered through the transform T, the volumetric image L(x,y,z) is then analyzed to determine a transformation, T_{1/2}. The transformation, T_{1/2} transforms the image L(x,y,z) such that the mid-sagittal plane of the object to be imaged is located on the center slice of the field of view. In one embodiment, T is halved in the Riemannian space of all rigid transforms to arrive in T_{1/2}. The halving of T can be implemented if T is represented as a combination of rotation, R, and translation, t. The rotation part may be further represented as a quaternion:

R=[u,v,w,r], where u²+v²+w²+r²=1.

and t=(tₓ, t_{y}, t_{z}). With this representation, the rotation part and translation part of the rigid transform T_{1/2}, are

$${R}_{1 / 2} = [ \frac{u}{\sqrt{2 ( 1 + r )}} , \frac{v}{\sqrt{2 ( 1 + r )}} , \frac{w}{\sqrt{2 ( 1 + r )}} , \sqrt{\frac{1 + r}{2}} ] , \\ {t}_{1 / 2} = [ \frac{{t}_{x}}{2} , \frac{{t}_{y}}{2} , \frac{{t}_{z}}{2} ] .$$

Referring back to FIG. 2, at block 120, the position and orientation of the object is estimated using the volumetric image and the transformed volumetric image. Since the mid-sagittal plane of the object is located on the center slice in the field of view under transform T_{1/2}, M(y,z) may be represented as:

M(y,z)=L(T_{1/2}⁻¹(0,y,z)).

Since T_{1/2}⁻¹(0,y,z) does not necessarily fall on an image grid (or voxel), the data from the volumetric image may be interpolated to determine the distribution of signal intensities. Next, the symmetry plane image, M(y,z) is registered to a reference mid-sagittal plane image, MR(y,z) to determine a two-dimensional rigid transform Tc that aligns M(y,z) with MR(y,z). In one embodiment the reference mid-sagittal plane image may be obtained from one or more previously acquired or computed symmetry plane images of the same object. In another embodiment, the reference mid-sagittal plane image may be obtained from one or more previously acquired or computed symmetry plane images of a different object. In yet another embodiment, the reference mid-sagittal plane image may be obtained from one or more previously acquired or computed symmetry plane images of a standard object.

Skipping ahead to FIG. 4, a block diagram illustrating an image registration process for aligning an image of the object's mid-sagittal plane, M(y,z) (170) to the reference mid-sagittal plane image M_{R}(y,z) (175) is shown. In a similar manner as described with respect to FIG. 3, the image registration process of FIG. 4 is an iterative process through which an image similarity measure 180 is used to quantify how similar the object mid-sagittal plane 170 and the reference mid-sagittal plane 175 are. In one embodiment, an optimization process 185 is used to update a rigid two-dimensional transform 190 between the object mid-sagittal plane, M(y,z) (170) and the reference mid-sagittal plane image M_{R}(y,z) (175) so as to maximize the similarity measure between the two. The result of this registration step is transform T_{c}.

Referring back to FIG. 2, as illustrated by block 130, the estimated position and orientation of the object is used by the computer 20 and/or processing module 35 to prescribe the appropriate MR scan plane. In one embodiment, the estimated position and orientation of the object is determined through the combination of the first rigid transform T_{1/2} and the second rigid transform T_{c} resulting in a final rigid transform T_{F}. For example, suppose T_{1/2} and T_{c} are represented in matrix form as

$${T}_{1 / 2} = ( \begin{matrix}{c}_{11} & {c}_{12} & {c}_{13} & \frac{{t}_{x}}{2} \\ {c}_{21} & {c}_{22} & {c}_{23} & \frac{{t}_{y}}{2} \\ {c}_{31} & {c}_{32} & {c}_{33} & \frac{{t}_{z}}{2} \\ 0 & 0 & 0 & 1\end{matrix} ) , \\ {T}_{c} = ( \begin{matrix}{e}_{11} & {e}_{12} & {f}_{1} \\ {e}_{21} & {e}_{22} & {f}_{2} \\ 0 & 0 & 1\end{matrix} ) ,$$

the final transform TF can be obtained as a matrix multiplication:

$${T}_{F} = ( \begin{matrix}{c}_{11} & {c}_{12} & {c}_{13} & \frac{{t}_{x}}{2} \\ {c}_{21} & {c}_{22} & {c}_{23} & \frac{{t}_{y}}{2} \\ {c}_{31} & {c}_{32} & {c}_{33} & \frac{{t}_{z}}{2} \\ 0 & 0 & 0 & 1\end{matrix} ) \times ( \begin{matrix}1 & 0 & 0 & 0 \\ 0 & {e}_{11} & {e}_{12} & {f}_{1} \\ 0 & {e}_{21} & {e}_{22} & {f}_{2} \\ 0 & 0 & 0 & 1\end{matrix} )$$

The transform T_{F} is then used to modify the MR scan plane to obtain the desired view.

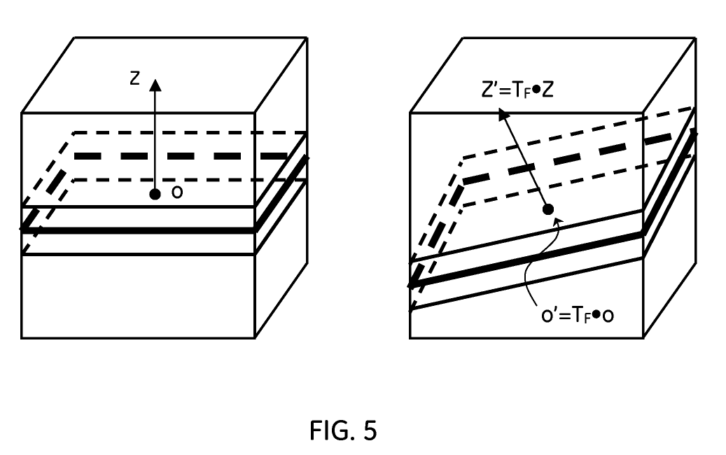

FIG. 5 is a schematic diagram illustrating how the transform T_{F} may be used to generate a new scan plane, in accordance with one embodiment. For example, suppose a plane defined by a point o and a vector z is given in the anatomy space. The point that corresponds to point o in the object space is o′=T_{F}·o, and the vector z corresponds to z′=T_{F}·z. The point o′ and vector z′ define the scan plane in the object space.

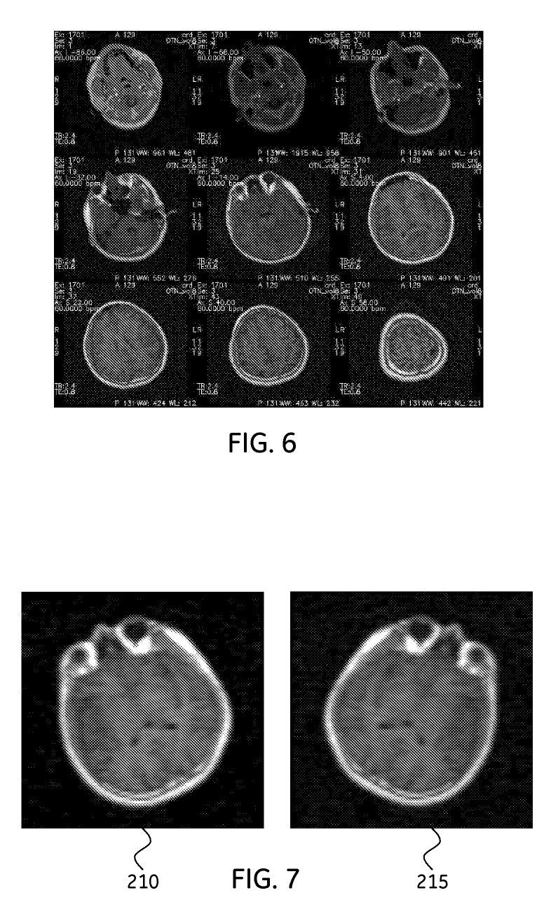

FIG. 6 illustrates nine consecutive slices of an axial volumetric localizer image of a human brain.

FIG. 7 illustrates one image slice in the localizer image (210) and its flipped version around the initial guess of the plane of symmetry (215).

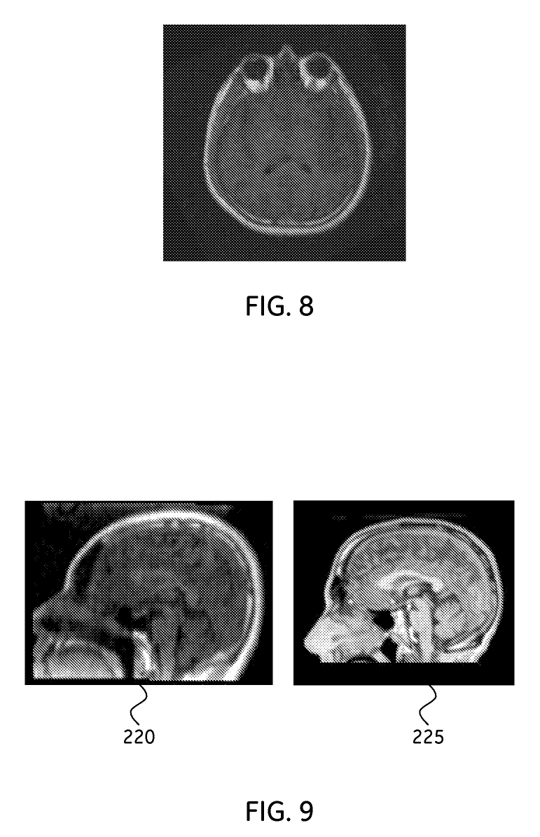

In FIG. 8, the image slice 210 from FIG. 7 is transformed by T_{1/2} such that the mid-sagittal plane of the object is on the center (e.g., left-right center) slice of the field of view.

FIG. 9 illustrates an image of the mid-sagittal plane of the object (220) and the reference mid-sagittal plane image (225).

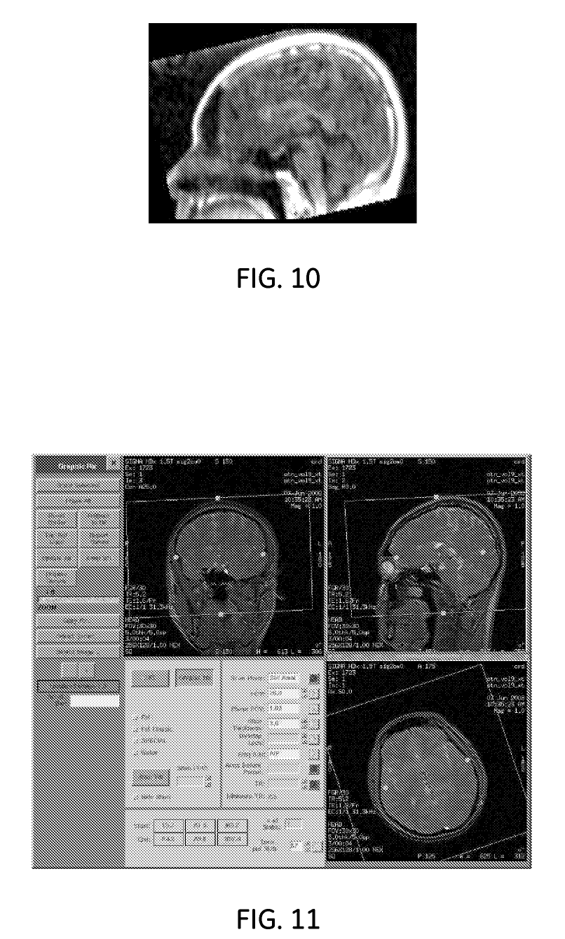

FIG. 10 illustrates the image of the mid-sagittal plane of the object transformed by T_{c} so that it is in better alignment with the reference mid-sagittal plane image shown as image 225 in FIG. 9.

FIG. 11 is a screen shot illustrating that a processing system, such as computer 20, which controls the scanner, uses the information of the position and orientation of the object to prescribe the imaging planes and field of views (rectangular boxes) to acquire diagnostic images.

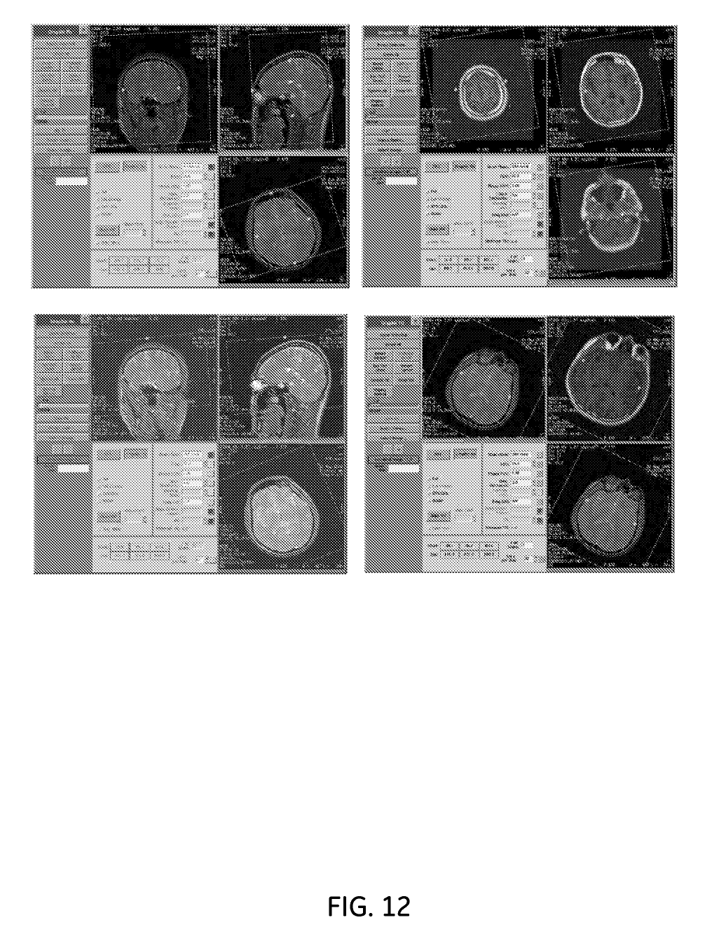

FIG. 12 illustrates additional screen shots on an MR scanner console, such as from imaging system 10, with prescribed scan plane and field of view for different objects with various positions and orientations.

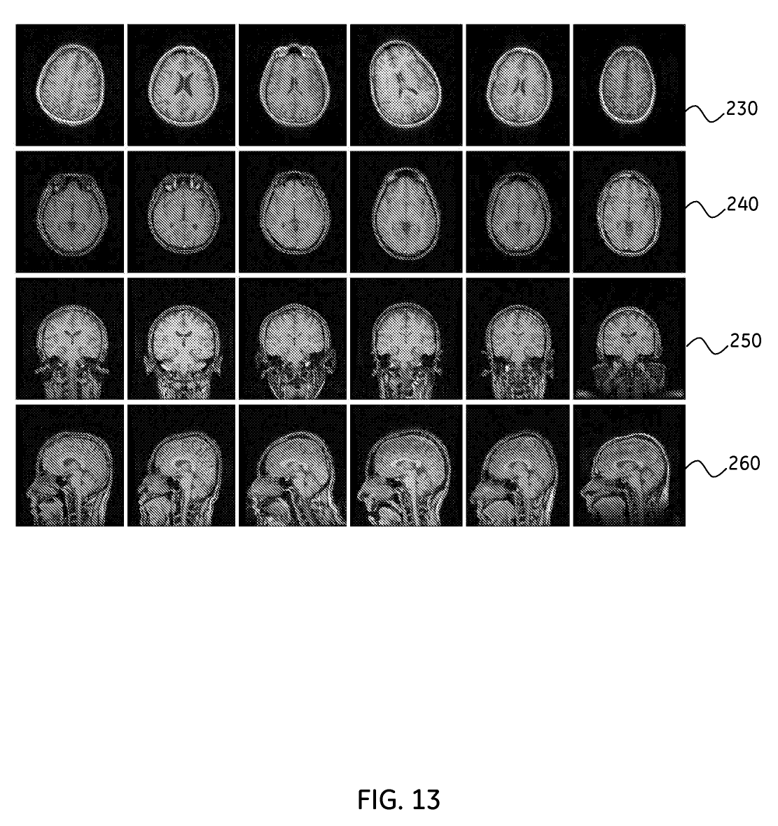

FIG. 13 illustrates six typical results (from left to right) of scans prescribed using the methods and systems described herein. Row 230 represents an axial slice of a localizer, row 240 represents an axial slice in the standard axial view, row 250 represents a coronal slice in the standard coronal view; and row 260 represents a sagittal slice in the standard sagittal view.

The above-description of the embodiments of the method for reconstructing an image and the system for reconstructing an image have the technical effect of improving workflow by enhancing image quality and reducing image artifacts, thereby allowing acceleration of image processing applications.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method of determining an anatomically consistent imaging scan protocol for an object of interest, comprising:
obtaining a volumetric image of an object of interest to be imaged;
transforming the volumetric image;
estimating a position and orientation of the object using the volumetric image and the transformed volumetric image; and
modifying the imaging scan protocol using the estimated object position and orientation.

2. The method of claim 1, further comprising determining a plane of symmetry represented by a first rigid transform of the object of interest based on spatial distribution of signal intensities of the object without use of landmarks.

3. The method of claim 2, wherein obtaining the volumetric image comprises obtaining a spatial distribution of signal intensities of the object.

4. The method of claim 3, wherein the volumetric image comprises a two-dimensional or three-dimensional image.

5. The method of claim 3, wherein the volumetric image is oriented in more than one direction.

6. The method of claim 3, wherein the plane of symmetry is computed from the volumetric image.

7. The method of claim 2, wherein determining a plane of symmetry further comprises registering the volumetric image to a transformed version of itself.

8. The method of claim 7, wherein transforming comprises reflecting the volumetric image around an arbitrary initial guess of the plane of symmetry.

9. The method of claim 7, wherein registering comprises optimizing an image similarity measure.

10. The method of claim 9, wherein the image similarity measure comprises mutual information of a plurality of images.

11. The method of claim 9, wherein the image similarity measure comprises a cross-correlation of a plurality of images.

12. The method of claim 9, wherein the image similarity measure comprises a least-squares error metric of a plurality of images.

13. The method of claim 2, further comprising estimating the orientation of the object in the plane of symmetry represented by a second rigid transform based on a distribution of signal intensity in the plane of symmetry.

14. The method of claim 2, further comprising determining a distribution of the signal intensities of the object by interpolating the data from the volumetric image.

15. The method of claim 2, wherein estimating the orientation of the object comprises registering an image of the plane of symmetry of the object to a reference symmetry plane image.

16. The method of claim 15, wherein the reference symmetry plane image is obtained from a previously acquired or computed symmetry plane image of the same object.

17. The method of claim 15, wherein the reference symmetry plane image is obtained from a previously acquired or computed symmetry plane image of a different object.

18. The method of claim 15, wherein the reference symmetry plane image is obtained from a previously acquired or computed symmetry plane image of a standard reference.

19. The method of claim 15, wherein the reference symmetry plane image is obtained from a plurality of previously acquired or computed symmetry plane images.

20. The method of claim 13, further comprising combining the first transform and the second transform to produce a complete representation of the orientation and position of the object of interest.

21. The method of claim 20, wherein the complete representation of the orientation and position of the object of interest is represented by a third rigid transform.

22. A machine readable medium comprising instructions, which when executed by a processor cause an imaging system to
obtain a volumetric image of an object of interest to be imaged;
transform the volumetric image;
estimate a position and orientation of the object using the volumetric image and the transformed volumetric image; and
modify the imaging scan protocol using the estimated object position and orientation.

23. The machine readable medium of claim 22, further comprising instructions, which when executed cause the imaging system to determine a plane of symmetry represented by a first rigid transform of the object of interest based on spatial distribution of signal intensities of the object without use of landmarks.

24. A magnetic resonance imaging system comprising the machine readable medium of claim 22.
